(19) United States
(12) Patent Application Publication
(10) Pub. No.: US 2026/0227035 A1
(43) Pub. Date: Aug. 6, 2026

(54) HYDROGEN TANK SYSTEM AND DIAGNOSTIC METHOD FOR A HYDROGEN TANK SYSTEM

(71) Applicant: Robert Bosch GmbH, Stuttgart (DE)

(72) Inventors: Stefan Kieferle, Stuttgart (DE); Birgit Lenz, Korntal (DE); Christian Schugger, Stuttgart (DE); Christian Kuhnert, Vaihingen/Enz (DE); Markus Strasser, Stuttgart (DE); Martin Schwab, Sindelfingen (DE); Nicolas Wussler, Esslingen Am Neckar (DE)

(21) Appl. No.: 19/149,153

(22) PCT Filed: Jan. 9, 2024
(86) PCT No.: PCT/EP2024/050377

§ 371 Date: Jul. 18, 2025

(30) Foreign Application Priority Data
Jan. 20, 2023 (DE) 10 2023 200 436.4

(51) Int. Cl. F17C 13/02

(52) U.S. Cl. CPC F17C 13/025; F17C 2221/012; F17C 2250/036; F17C 2250/0434

(57) ABSTRACT

The invention relates to a diagnostic method (100) for a medium pressure region of a hydrogen tank system (200),
wherein the diagnostic method (100) comprises:
   determining (101) a first pressure present in a medium pressure region of the hydrogen tank system (200) by means of a first pressure sensor (205) arranged at the medium pressure region,
   determining (103) a difference between the first pressure and a reference pressure determined by a second pressure sensor,
   comparing (105) the difference with a predetermined threshold value,
   storing (107) a result of the comparison in a memory at least in the event that the difference deviates from the threshold value.

### BACKGROUND

The invention relates to a diagnostic method for a hydrogen tank system and a hydrogen tank system according to the disclosure.

Hydrogen tank systems usually comprise a high pressure storage tank that feeds a pressure reducer with high pressure hydrogen via a high pressure region.

The pressure reducer separates the high pressure region from a medium pressure region into which hydrogen flows at a pressure set by the pressure reducer.

On the consumer side, a low pressure region is usually provided in which the pressure of the hydrogen flowing through the low pressure region is set by means of a flow valve.

Due to leaks and/or deformation of pipes in the medium pressure region, a pressure drop may occur in the medium pressure region. Furthermore, the sensor technology used to determine the medium pressure in the medium pressure region may be faulty, so that a downstream flow valve is not supplied with a predetermined pressure and is therefore unable to set a predetermined pressure in the low pressure region.

Accordingly, it is advantageous for the reliable operation of a hydrogen tank system or a hydrogen consumer to know or verify the current status of a medium pressure region of the hydrogen tank system.

### SUMMARY

The invention relates to a hydrogen tank system and a diagnostic method for diagnosing the condition of the hydrogen tank system. Further features and details of the invention arise from the respective dependent claims, the description, and the drawings. The features and details described in connection with the diagnostic method according to the invention naturally also apply in connection with the hydrogen tank system according to the invention and vice versa, so that mutual reference can always be made to the disclosure relating to the individual aspects of the invention.

The invention presented is particularly useful for diagnosing the condition of a hydrogen tank system. In particular, the invention presented serves to validate a pressure determined by a medium pressure sensor of a hydrogen tank system.

Accordingly, a diagnostic method for a medium pressure region of a hydrogen tank system is presented in accordance with a first aspect of the invention.

The diagnostic method presented comprises determining a first pressure present in a medium pressure region of the hydrogen tank system by means of a first pressure sensor arranged at the medium pressure region, determining a difference between the first pressure and a reference pressure determined by a second pressure sensor, comparing the difference with a predetermined threshold value, and storing a result of the comparison in a memory at least in the event that the difference deviates from the threshold value.

The diagnostic method presented is based on a comparison of measured values determined by a first pressure sensor arranged at a medium pressure region with measured values determined by a second pressure sensor or a corresponding reference pressure. There is a causal or physical connection between a first pressure determined by the first pressure sensor and a second pressure determined by the second pressure sensor.

To compare the measured values determined by the first pressure sensor and the second pressure sensor with a respective threshold value, a difference between the respective measured values is formed and the difference is mathematically related to the threshold value.

The threshold value can be a single value, an amount, or a range of values. Accordingly, a deviation of the difference from the threshold value in either a positive or negative direction can lead to the result of the comparison being stored in the memory.

For example, the medium pressure region can be coupled with a pressure region monitored by the second pressure sensor, in particular reversibly coupled, so that the same pressure can be set at the first pressure sensor and the second pressure sensor.

Alternatively, based on a predetermined mathematical relationship between the medium pressure region and another pressure region, such as a high pressure region supplying hydrogen to the medium pressure region, an expected value or a corresponding reference value for the first pressure can be determined from the second pressure.

By comparing the first pressure with a reference value determined on the basis of the second pressure, it can therefore be determined whether the first pressure, i.e. the pressure in the medium pressure region or a measured value determined by the first pressure sensor arranged at the medium pressure region, is plausible.

In particular, if the result of the comparison provided for in the invention deviates from the reference value, the result can be stored in a memory, such as an error memory of the hydrogen tank system or an error memory of a consumer supplied with hydrogen by the hydrogen tank system, for example as a plausibility message or as an error message.

Accordingly, the result can be output on an output unit, such as a display, or retrieved from the memory by a processing unit, such as a control device of the consumer.

In particular, the first pressure and the second pressure can be compared directly, i.e., using the respective sensor values or measured values. This can be done, for example, in the case of low mass flows in order to avoid pressure differences due to flow-related pressure drops in the pipe system between the first pressure sensor and the second pressure sensor, as is typical, for example, when the consumer system is at a standstill and/or at low power.

Alternatively, the first pressure and the second pressure can be compared with sensor values or measured values, taking into account expected pressure drops for a pipe system between the first pressure sensor and the second pressure sensor depending on the operating point, e.g., at increased to maximum output of the consumer system. The pressure drops expected at the operating point on the pipe system between the first pressure sensor and the second pressure sensor can be stored in a control unit, for example.

It may be provided that, if the difference is greater than the threshold value, the result is stored in the memory as an error message and/or that, if the difference is less than or equal to the threshold value, the result is stored in the memory as a plausibility check.

Since a difference greater than the threshold value indicates an unexpectedly large difference between the first pressure and the second pressure, it can be assumed that the first pressure is in an unexpected region and is therefore faulty.

Since a difference that is smaller than the threshold value indicates an expected difference or a difference within an acceptable range, it can be assumed that the first pressure is within an expected region and is therefore plausible.

It may also be provided that the second pressure sensor is arranged on a supply system for a consumer system fluidically coupled to the water tank system.

Since a supply system of a consumer system is usually coupled systemically with the medium pressure region in a fluid-conducting manner, a second pressure determined in the supply system is particularly advantageous for determining the reference pressure.

It may also be provided that the first pressure is determined at an operating point of the consumer at which mass flows between the first pressure sensor and the second pressure sensor are above a predetermined measured threshold value and, if the difference is greater than the threshold value, the method comprises setting a mass flow in a region between the first pressure sensor and the second pressure sensor that is below a predetermined fine measured threshold value, determining a first fine pressure present in a medium pressure region of the hydrogen tank system by means of the first pressure sensor, determining a fine reference pressure by means of the second pressure sensor, determining a fine difference between the first fine pressure and the fine reference pressure, comparing the fine difference with a predetermined fine threshold value, storing an error message of an error in a pipe system of the medium pressure region in the memory in the event that the fine difference is less than or equal to the fine threshold value, or storing an error message of an error of the first pressure sensor in the memory in the event that the fine difference is greater than the fine threshold value.

To distinguish a faulty pipe system, such as a deformed pipe or a cracked connector, from a faulty sensor, a two-stage process can be used, in which a difference between the measured values of the first pressure sensor and the second pressure sensor is first determined at high mass flows and then, at low mass flows, in particular at no mass flows or a consumer mass flow of “0,” a fine difference between the measured values of the first pressure sensor and the second pressure sensor is determined.

The two-stage process involves an initial sub-process to determine whether there is an error in the overall system. If such an error is detected, i.e., the difference deviates from the threshold value, e.g., a pressure drop in the medium pressure region does not correspond to an expected pressure drop stored in a control unit, for example. In a second sub-process, it is determined whether the error originates from the sensor technology or from the pipe system. The assumption here is that if the differential pressure is less than or equal to the fine threshold value, the sensor system is OK and there must be an error in the pipe system.

It may also be provided that the second pressure sensor is arranged on an external pressure system.

By means of an external pressure system, such as an external system connected to a so-called “bleed port” behind a pressure regulator and/or a filling/flushing station, the difference provided for in the invention can be determined at defined pressures within the expected pressure region of the medium pressure system, e.g. from zero pressure to the control pressure of the pressure regulator.

It may also be provided that the second pressure sensor is arranged at a high pressure region of the hydrogen tank system.

In a high pressure region of the hydrogen tank system, a function can be performed to reduce the pressure in the high pressure system and medium pressure system to a predetermined pressure region at which the pressure regulator is open. This function can set the pressure reduction, for example, by means of targeted mass withdrawal after the tank valves of the hydrogen tank system have been closed when a respective consumer is switched off and/or during operation, or during an empty tank run in which the pressure level falls below the normal control pressure region of the pressure regulator.

It may also be provided that the second pressure sensor is configured to detect an ambient pressure of the hydrogen pressure system as a reference pressure.

Ambient pressure can be used as a reference pressure, for example, when the medium pressure system is depressurized, e.g., at the factory and/or in a service workshop and/or when the consumer system is open and therefore depressurized.

It may also be provided that the high pressure region is connected to the medium pressure region via a pressure regulator in such a way that fluid can flow between them.

A fluid-conducting connection between the high pressure region and the medium pressure region by means of a pressure regulator allows the pressure in the high pressure region to be changed via the pressure regulator by the pressure regulator responding to a pressure change in the medium pressure region.

It may also be provided that the initial pressure is determined by a number of measured values determined by the first pressure sensor during a number of predetermined operating conditions of the hydrogen tank system, and/or the reference pressure is determined by a number of measured values determined by the second pressure sensor during a number of predetermined conditions.

A number, in particular a large number, of measured values from the first pressure sensor and/or the second pressure sensor can be used to monitor, in particular, the behavior of the medium pressure region over time under various operating conditions.

It may also be provided that the number of predetermined operating conditions comprises at least one operating condition from the following list of operating conditions: pressureless state of the medium pressure region of the hydrogen tank system, a predetermined pressure curve in the medium pressure region which leads to the opening of a pressure regulator of the hydrogen tank system and to pressure equalization between the high pressure region and the medium pressure region.

According to a second aspect, the invention relates to a hydrogen tank system.

The hydrogen tank system shown comprises a first pressure sensor arranged at a medium pressure region of the hydrogen tank system and a computing unit, wherein the first pressure sensor is set up to detect a pressure in the medium pressure region, and wherein the computing unit is set up to carry out a possible configuration of the diagnostic method shown.

Further advantages, features, and details of the invention arise from the following description, in which exemplary embodiments of the invention are described in detail with reference to the drawings. In this context, the features mentioned in the claims and in the description can each be essential to the invention individually or in any combination.

### BRIEF DESCRIPTION OF THE DRAWINGS

The following is shown:

FIG. 1 a possible embodiment of the diagnostic method present,

FIG. 2 a schematic representation of a possible design for the hydrogen tank system presented.

### DETAILED DESCRIPTION

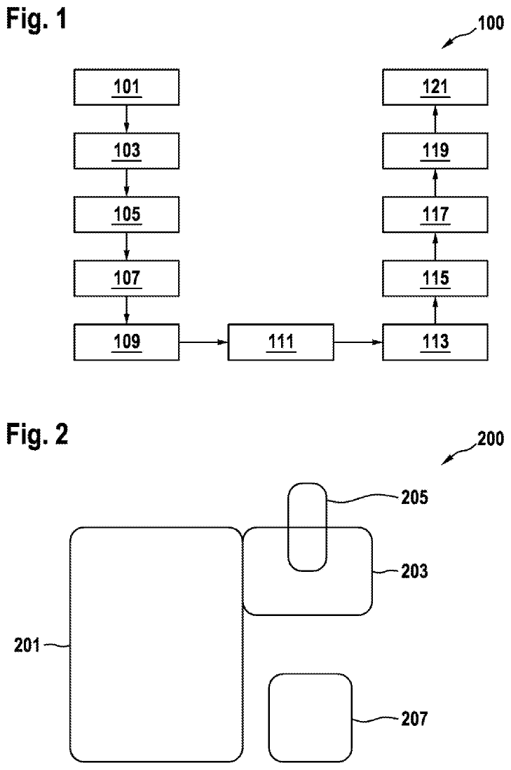

FIG. 1 shows a diagnostic method 100 for diagnosing an error in a medium pressure region of a hydrogen tank system.

The diagnostic method 100 comprises a determination step 101 in which a first pressure present in a medium pressure region of the hydrogen tank system is determined by means of a first pressure sensor arranged at the medium pressure region, a determination step 103 in which a difference between the first pressure and a reference pressure detected by a second pressure sensor is determined, a comparison step 105, in which the difference is compared with a predetermined threshold value, and a storage step 107, in which a result of the comparison step 105 is stored in a memory at least for the case that the difference deviates from the threshold value.

Optionally, the diagnostic method 100 comprises a setting step 109 in which a mass flow rate is set in a region between the first pressure sensor and the second pressure sensor that is below a predetermined fine measured threshold value, a determination step 111, in which a first fine pressure present in a medium pressure region of the hydrogen tank system is determined by means of the first pressure sensor, a further determination step 113, in which a fine reference pressure is determined by means of the second pressure sensor, a determination step 115, in which a fine difference between the first fine pressure and the fine reference pressure is determined, and a comparison step 117, in which the fine difference is compared with a predetermined fine threshold value.

Furthermore, the diagnostic method 100 optionally comprises a storage step 119, in which an error message of an error in a pipe system of the medium pressure region is stored in the memory in the event that the fine difference is less than or equal to the fine threshold value, or a storage step 121, in which an error message of an error of the first pressure sensor is stored in the memory in the event that the fine difference is greater than the fine threshold value.

FIG. 2 shows a hydrogen tank system 200. The hydrogen tank system 200 comprises a high pressure region 201 and a medium pressure region 203, as well as a first pressure sensor 205 and a computing unit 207.

The first pressure sensor 205 is configured to detect a pressure in the medium pressure region 203.

The processing unit 207 is configured to perform the diagnostic method 100 according to FIG. 1.

1. A diagnostic method (100) for a medium pressure region of a hydrogen tank system (200),
wherein the diagnostic method (100) comprises:
determining (101) a first pressure present in a medium pressure region of the hydrogen tank system (200) by means of a first pressure sensor (205) arranged at the medium pressure region,
determining (103) a difference between the first pressure and a reference pressure determined by a second pressure sensor,
comparing (105) the difference with a predetermined threshold value,
storing (107) a result of the comparison in a memory when the difference deviates from the threshold value.

2. The diagnostic method (100) according to claim 1,
wherein
if the difference is greater than the threshold value, the result is stored in the memory as an error message and/or that if the difference is less than or equal to the threshold value, the result is stored in the memory as a plausibility check.

3. The diagnostic method (100) according to claim 1,
wherein
the second pressure sensor is arranged on a supply system for a consumer system fluidly coupled to the hydrogen tank system (200).

4. The diagnostic method (100) according to claim 3,
wherein
the determination (101) of the first pressure takes place at an operating point of the consumer at which mass flows between the first pressure sensor (205) and the second pressure sensor are above a predetermined measured threshold value, and when the difference is greater than the threshold value, the method further comprises:
setting (109) a mass flow in a region between the first pressure sensor (205) and the second pressure sensor, which is below a predetermined fine measured threshold value,
determining (111) a first fine pressure prevailing in a medium pressure region (203) of the hydrogen tank system (200) by means of the first pressure sensor,
determining (113) a fine reference pressure by means of the second pressure sensor,
determining (115) a fine difference between the first fine pressure and the fine reference pressure,
comparing (117) the fine difference with a predetermined fine threshold value,
storing (119) an error message of an error in a pipe system of the medium pressure region (203) in the memory when the fine difference is less than or equal to the fine threshold value, or
storing (121) an error message of an error of the first pressure sensor (205) in the memory when the fine difference is greater than the fine threshold value.

5. The diagnostic method (100) according to claim 1,
wherein
the second pressure sensor is arranged on an external pressure system.

6. The diagnostic method (100) according to claim 1,
wherein
the second pressure sensor is arranged at a high pressure region (201) of the hydrogen tank system (200).

7. The diagnostic method (100) according to claim 1,
wherein
the second pressure sensor is configured to detect an ambient pressure of the hydrogen pressure system (200) as a reference pressure.

8. The diagnostic method (100) according to claim 6,
wherein
the high pressure region (201) is connected to the medium pressure region (203) in a fluid-conducting manner via a pressure regulator.

9. The diagnostic method (100) according to claim 1,
wherein
the first pressure is determined by a number of measured values determined by the first pressure sensor (205) during a number of predetermined operating conditions of the hydrogen tank system (200), and/or the reference pressure is determined by a number of measured values determined by the second pressure sensor during a number of predetermined conditions.

10. The diagnostic method (100) according to claim 9,
wherein
the number of predetermined operating conditions comprises at least one operating condition selected from the group consisting of the following operating conditions:
pressureless state of the medium pressure region (203) of the hydrogen tank system (200), and a predetermined pressure curve in the medium pressure region (203), which leads to opening of a pressure regulator of the hydrogen tank system (200) and to pressure equalization between a high pressure region (201) and the medium pressure region (203).

11. A hydrogen tank system (200),
wherein the hydrogen tank system (200) comprises:
a first pressure sensor (205) arranged at a medium pressure region (203) of the hydrogen tank system (200), and
a processing unit (207),
wherein the first pressure sensor (205) is configured to detect a pressure in the medium pressure region (203), and
wherein the processing unit (207) is configured to perform a diagnostic method (100) according to claim 1.
